(19) United States
(12) Patent Application Publication
(10) Pub. No.: US 2016/0096998 A1
(43) Pub. Date: Apr. 7, 2016

(54) PROCESSES AND SYSTEMS FOR PRODUCING LIQUID TRANSPORTATION FUELS

(71) Applicant: COMMUNITY POWER CORPORATION, ENGLEWOOD, CO (US)

(72) Inventor: Steve Sherwood, Highlands Ranch, CO (US)

(21) Appl. No.: 14/863,056

(22) Filed: Sep. 23, 2015

Related U.S. Application Data
(60) Provisional application No. 62/054,214, filed on Sep. 23, 2014.

(51) Int. Cl. C10G 2/00; C01B 3/34; C10G 11/05; C10J 3/82; C10G 11/00

(52) U.S. Cl. CPC C10G 2/34; C10J 3/82; C10G 11/00; C10G 11/05; C01B 3/34; C10J 2300/1659; C10J 2300/0916; C01B 2203/0211; C01B 2203/062

(57) ABSTRACT

Disclosed in the application include systems and processes for producing a liquid transportation fuel product using a carbon-containing feedstock. Also disclosed include catalysts that can be used in the systems and the processes, and processes of making the catalysts.

### PRIORITY CLAIM

This application claims the benefit of U.S. Provisional Application No. 62/054,214 filed Sep. 23, 2014, which is hereby incorporated by reference in its entirety.

### BACKGROUND

Commercial Gas-to-Liquid (GTL) systems for converting natural gas into a hydrocarbon liquid transportation fuel are often based on a multiplicity of complex refinery-based operations using oxygen-blown conversion of natural gas (or other fossil fuel-based resources) into synthesis gas (a.k.a. syngas) containing hydrogen (H2) and carbon monoxide (CO). The syngas can be converted into a liquid hydrocarbon fuel and/or wax through a series of Fischer-Tropsch Synthesis (FTS) reactions.

### BRIEF DESCRIPTION OF THE DRAWINGS

FIG. 1 illustrates a part of an exemplary system including three processing units in fluid connection in series. The illustrated part includes a train of LIQUIMAX® Fischer-Tropsch (F-T) reactors.

FIG. 2 is a schematic of an exemplary embodiment of the product upgrading unit that can be part of the system.

### SUMMARY

Some of the embodiments include a system for converting a carbon-containing feedstock into a liquid transportation fuel product. The carbon-containing feedstock can include at least one feedstock selected from the group consisting of, for example, a ligno-cellulosic biomass solid, a biomass derived oil, a biomass derived gas, a fossil-fuel derived carbonaceous feedstock, and the like. The liquid transportation fuel product can include at least one product selected from the group consisting of, for example, a gasoline product, a diesel product, a jet fuel product, and the like. The liquid transportation fuel product can meet a commercial fuel specification.

The system can include an air-blown producer gas reactor operable to convert the carbon-containing feedstock into a producer gas, a processing unit, and a product upgrading unit. The producer gas can include, for example, H₂, CO, CO₂, and N₂, and the like. The producer gas can include substoichiometeric amounts of H₂ and CO (less than 2:1 molar ratio of H₂ to CO). The processing unit can include a Fischer-Tropsch (F-T) reactor and a cracker. The F-T reactor can be fluidly coupled to a source of feed gas and operable to convert at least a portion of the feed gas into a FTS product, wherein the FTS product can include, for example, the liquid transportation fuel product and a first residue. The cracker can be fluidly coupled to the F-T reactor and operable to catalytically crack at least a portion of the first residue to produce an additional amount of the liquid transportation fuel product and a second residue. The product upgrading unit can be operable to produce an additional amount of the liquid transportation fuel product from a product gas. The processing unit can include a hard-wax trap that can be fluidly coupled to the F-T reactor and/or the cracker. At least a portion of the first residue and/or at least a portion of the second residue can be delivered to the hard-wax trap, wherein the hard-wax trap is adapted for separating and/or recovering an additional amount of the liquid transportation fuel product and a mixture from a hard-wax product. The product gas can include at least a portion of the first residue or at least a portion of the second residue. The product gas can include the mixture. The F-T reactor can be fluidly coupled to the air-blown producer gas reactor, wherein the feed gas to the F-T reactor can include the producer gas. The system can include more than one processing unit, wherein the feed gas of the F-T reactor of at least one of the processing units can include the producer gas from the air-blown producer gas reactor, wherein the feed gas of the F-T reactor of at least one of the processing units can include at least a portion of the FTS product generated in another F-T reactor of the system. At least some of the more than one processing units can be fluidly coupled in series. At least some of the more than one processing unit can be fluidly coupled in parallel. The system can include at least one soft-wax trap. If the system includes more than one processing unit, at least one of the processing units can include a soft-wax trap. The soft-wax trap can be fluidly coupled to the F-T reactor. The soft-wax trap can be operable to separate and/or recover an additional amount of the liquid transportation fuel product from the feed gas before the feed gas enters the F-T reactor. The system can include at least one gas preheater. If the system includes more than one processing unit, at least one of the processing units can include a gas preheater. The gas preheater can be fluidly coupled to the F-T reactor of the processing unit. The gas preheater can be operable to preheat the feed gas. The soft-wax trap can be fluidly coupled between the gas preheater and the F-T reactor, wherein the soft-wax trap can be operable to separate and/or recover an additional amount of the liquid transportation fuel product from the preheated feed gas before the preheated feed gas enters the F-T reactor. The product upgrading unit can include at least one apparatus selected from the group consisting of, for example, a condenser, a hydrogenation apparatus, a distillation apparatus, an isomerization apparatus, a molecular-sieve polishing apparatus, an activated-carbon polishing apparatus, a hydrogen membrane, and the like. The product upgrading unit can generate a third residue. The third residue can be delivered to the F-T reactor fluidly coupled with the product upgrading unit for further processing.

At least one of the F-T reactors can include a catalyst, wherein the catalyst can be operable to catalyze a Fischer-Tropsch Synthesis (FTS) reaction. The catalyst can include, for example, iron. In embodiments, the iron catalyst is derived from a natural source. In preferred embodiments, the iron catalyst is a titanomagnitite derived from a natural source, for example, titano-magnetic black volcanic sands. In embodiments, the iron catalyst may further comprise copper. The iron catalyst can be promoted by, for example, a Group 1 metal. The catalyst can be operable to catalyze a Water-Gas-Shift (WGS) reaction between water (H₂O) and carbon monoxide (CO). The iron catalyst may be pelletized with clay and/or a silica-based binding agent. The iron catalyst may also be reduced and/or converted to an active FT catalyst as described herein. At least one of the crackers in the processing unit or in the product upgrade unit can include a cracking catalyst. The cracking catalyst can include, for example, a zeolite, which can catalytically crack at least one composition selected from the group consisting of, for example, a wax, an aromatized light olefin, and the like. The cracking catalyst can include a ZSM-5 zeolite. The hydrogenation apparatus can include a hydrogenation catalyst. The hydrogenation catalyst can include, for example, palladium or platinum on alumina. The isomerization apparatus can include an isomerization catalyst. The isomerization catalyst can include, for example, a ferrierite zeolite catalyst.

Some embodiments of the application include a method for converting a carbon-containing feedstock into a liquid transportation fuel product using the system described herein. The carbon-containing feedstock can include at least one feedstock selected from the group consisting of, for example, a ligno-cellulosic biomass solid, a biomass-derived oil, a biomass-derived gas, a fossil-fuel derived carbonaceous feedstock, and the like. The method can include adding a fuel additive to the liquid transportation fuel product, thereby rendering the liquid transportation fuel product to meet a commercial fuel specification.

Some embodiments of the application include a method for converting a carbon-containing feedstock into a hydrocarbon wax. The method can include converting the carbon-containing feedstock into a producer gas including, for example, H₂, CO, CO2, and N₂; reacting the producer gas with a substrate catalyst to produce a FTS product including, for example, a hydrocarbon gas, a liquid, a first portion of the hydrocarbon wax, and the like, and reacting at least a portion of the hydrocarbon gas and liquid with the substrate catalyst to produce a second portion of the hydrocarbon wax.

### DETAILED DESCRIPTION

In some embodiments, the numbers expressing quantities of ingredients, properties, such as molecular weights, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

The main Fischer-Tropsch Synthesis (FTS) reaction can include the conversion of hydrogen and carbon monoxide into the liquid hydrocarbon fuel and water:

nCO+2nH₂ [symbol] -{CH2}ₙ₋+nH₂O (Reaction 1: FTS)

A catalyst can be used in Reaction 1. From this reaction, each molecule of CO can react with two molecules of H₂ to produce hydrocarbon products including, for example, liquid fuels and waxes, and one molecule of H₂O (water).

In a Biomass-to-Liquid (BTL) system, the gasification of biomass produce a hydrogen-deficient syngas (producer gas containing approximately a 1:1 molar ratio of CO:H₂) that may not sustain the FTS reaction. For such a systems, CO:H₂ ratio can be adjusted through a Water-Gas-Shift (WGS) reaction that can convert at least a portion of the CO in the feed gas to the FTS reaction to H₂ and CO₂:

CO+H₂O [symbol] H₂+CO₂ (Reaction 2: WGS)

In some embodiments, the WGS reaction can be catalyzed by, for example, an iron-based FTS catalyst and approximately one-half of the CO in the producer gas can react with an equal molar amount of water (from the FTS reaction) to produce H₂ and CO₂. The remaining CO can be converted to FTS products.

In most large-scale GTL systems, highly-polished syngas gas (containing only CO and H₂) can be converted to heavy paraffinic FTS waxes at pressures of 250 to 450 psig. In a series of refinery-based operations, at least a portion of the FTS wax products can be processed by way of, for example, cracking, hydrogenation, or the like, or a combination thereof, into a product including, for example, gasoline, a diesel-fuel product, or the like, or a combination thereof. These GTL facilities can usually be very large (e.g., several thousands of barrels of a diesel product per day) and can need on-site oxygen and/or hydrogen generation plants to support the gasification and fuel upgrading systems.

The conventional wisdom is that a small biorefinery would be expected to have poor economics. However, a small-scale biorefinery can allow the use of low, or even negative cost feedstocks, at their source, thereby eliminating transportation and/or distribution costs. By using this paradigm in conjunction with a greatly simplified conversion process, and locating the system where competing fuel prices are high, a cost effective small-scale biorefinery can become feasible.

In contrast to the present trend of building large GTL refineries, embodiments of the present application are directed to systems and methods for converting a carbon-containing feedstock using modular LIQUIMAX® technology. The technology can couple small modular liquid fuel processing units with automated air-blown BIOMAX® gasifiers, other solid gasifiers or a proprietary low-cost Hydrocarbon Reformer, thereby providing a distributed micro-biorefinery for on-site generation of a liquid fuel product. The systems and methods can convert a producer gas (e.g., a nitrogen-diluted syngas containing nominally 50 vol % N₂, 20 vol % CO, 20 vol % H₂, and 10% CO₂) made from a low-cost residue (carbon-containing feedstock), directly to a liquid transportation fuel product (including, for example, gasoline, diesel, jet fuel, or the like, or a combination thereof) in a three-stage, single-pass system. The liquid transportation fuel product can supplement or replace conventional fossil liquid fuels. In the present application, the terms “liquid transportation fuel” and “fluid transportation fuel” are generally used interchangeably.

Some embodiments of the application include a system for converting a carbon-containing feedstock into a liquid transportation fuel product. The system can include a producer gas reactor, a processing unit, and a product upgrading unit. The liquid transportation fuel product can include at least one product selected from the group consisting of, for example, a gasoline product, a diesel product, a jet fuel product, and the like. It is understood that the liquid fuel product that can be generated by the system or method disclosed herein can be used for a purpose other than a liquid transportation fuel, although it can be referred to as a liquid transportation fuel product.

In some embodiments, the carbon-containing feedstock suitable for the system can include, for example, woody biomass, non-woody biomass, cellulosic biomass, cardboard, fiber board, paper, plastic, food stuff, human refuse (e.g., from a waste dump), or the like, or a combination thereof. The carbon-containing feedstock can include at least one feedstock selected from the group consisting of, for example, a ligno-cellulosic biomass solid, a biomass derived oil, a biomass derived gas, a fossil-fuel derived carbonaceous feedstock, and the like. Many types of biomass have low levels of sulfur and heavy metal contaminants, compared with conventional hydrocarbon fuel sources such as, for example, oil and coal.

In some embodiments, the system can include a drying apparatus for adjusting the moisture content of the carbon-containing feedstock. The drying apparatus can include a dryer that can blow dry and/or hot air to the carbon-containing feedstock. Merely by way of example, the drying apparatus can include a pipe that can blow dry and/or hot air to the carbon-containing feedstock. The pipe can be located along one or more portions of a conveyor that can deliver the carbon-containing feedstock to a producer gas reactor of the system. As another example, the drying apparatus can include a chamber where the carbon-containing feedstock can be dried by, for example, dry and/or hot air blown or generated therein. The moisture content of the carbon-containing feedstock can be adjusted to below 30 wt. %, or below 25 wt. %, or below 20 wt. %, or below 15 wt. %. or below 10 wt. %, or below 5 wt. %. or from 5 wt. % to 30 wt. %, or from 5 wt. % to 25 wt. %, or from 5 wt. % to 20 wt. %.

In some embodiments, the producer gas reactor can be operable to convert the carbon-containing feedstock into a producer gas including, for example, H₂, CO, CO₂, N₂, and the like. The producer gas reactor can include a gasification reactor that can convert a carbon-containing feedstock and air into a producer gas. An exemplary producer gas reactor can be found at, for example, U.S. Pat. No. 7,909,899 entitled “METHOD AND APPARATUS FOR AUTOMATED, MODULAR, BIOMASS POWER GENERATION,” which is hereby incorporated by reference. The producer gas reactor can also include an air-blown reforming system (e.g., air-blown producer gas reactor) that can convert gaseous or liquid hydrocarbons into a producer gas. The producer gas can include substoichiometeric amounts of H₂ and CO (i.e. less than 2:1 molar ratio of H₂ to CO). Merely by way of example, the producer gas can include a nitrogen-diluted syngas containing nominally 50 vol % N₂, 20 vol % CO, 20 vol % H₂, and 10% CO₂.

In some embodiments, the system can include a compressor system to compress the producer gas to increase the pressure before it is further processed, e.g., before it is fed to a Fischer-Tropsch (F-T) reactor or another apparatus (e.g., a gas preheater) in a processing unit. The compressor system can include one or more compressors. In some embodiments, the compressor system can be configured to work in parallel. In some embodiments, the compressor system can be configured to work in series. Merely by way of example, the compressor system can include two compressors configured such that the producer gas can be compressed to an intermediate pressure in the first compressor, and compressed to a higher pressure of a desired magnitude in the second compressor. The pressure of the producer gas exiting the compressor (or the last compressor if there are more than one in the compressor system) can be less than 500 psig, or less than 480 psig, or less than 450 psig, or less than 420 psig, or less than 400 psig, or less than 380 psig, or less than 350 psig, or less than 320 psig, or less than 300 psig, or less than 280 psig, or less than 250 psig, or less than 220 psig, or less than 200 psig. If the compressor system can include more than one compressor configured in series, a compressor of the compressor system can increase the pressure of the procedure gas by at least 20 psig, or at least 50 psig, or at least 80 psig, or at least 100 psig, or at least 120 psig, or at least 150 psig, or at least 180 psig, or at least 200 psig.

In some embodiments, the system can include at least one apparatus selected from the group consisting of, for example, a sulfur removal column, an activated-carbon clean-up column, an oxygen removal column, and the like. One or more of such apparatuses can be used to clean the producer gas and/or feed gas before it is delivered to an F-T reactor or another apparatus (e.g., a gas preheater) in a processing unit. The system can include at least one apparatus, e.g., a valve, a flow controller, or the like, that can control the flow rate of the producer gas and/or feed gas delivered to an F-T reactor or another apparatus (e.g., a gas preheater) in a processing unit.

In some embodiments, the processing unit can include an F-T reactor and a cracker. The F-T reactor can be fluidly coupled to a source of feed gas. The F-T reactor can be operable to convert at least a portion of the feed gas into an FTS product. The FTS product can include the liquid transportation fuel product and a first residue. The cracker can be fluidly coupled to the F-T reactor. The cracker can be operable to catalytically crack at least a portion of the first residue to produce an additional amount of the liquid transportation fuel and a second residue. At least one of the first residue and the second residue can include, for example, the FTS product other than the liquid transportation fuel product that can include, for example, a gas, a wax, or the like, or a combination thereof. In some embodiments, the system can include more than one processing unit, wherein at least one of the processing units can include an F-T reactor and a cracker.

In some embodiments, the F-T reactor can be fluidly coupled to the producer gas reactor (e.g., air-blown producer gas reactor), wherein the feed gas can include the producer gas. The amount of the producer gas that can be processed by an F-T reactor can be at least 10 Nm³/hr, or at least 20 Nm³/hr, or at least 30 Nm³/hr, or at least 40 Nm³/hr, or at least 50 Nm³/hr, or at least 60 Nm³/hr, or at least 70 Nm³/hr, or at least 80 Nm³/hr, at least 90 Nm³/hr, or at least 100 Nm³/hr. The producer gas can include substoichiometeric amounts of H₂ and CO (i.e. less than 2:1 molar ratio of H₂ to CO). Merely by way of example, the producer gas can include a nitrogen-diluted syngas containing nominally 50 vol % N₂, 20 vol % CO, 20 vol % H₂, and 10% CO₂. The system can include at least one apparatus, e.g., a valve, a flow controller, or the like, that can control the flow rate of the producer gas and/or feed gas delivered to the F-T reactor.

In some embodiments, the system can include more than one processing unit. The feed gas delivered to an F-T reactor in a downstream processing unit can include at least a portion of the FTS product generated in another F-T reactor in an upstream processing unit of the system, and/or at least some of the feed gas delivered to but not consumed in another F-T reactor in an upstream processing unit of the system. Merely by way of example, an amount of liquid transport fuel product is recovered from the FTS product generated in an F-T reactor in an upstream processing unit, and at least a portion of the remaining FTS product can be delivered to an F-T reactor in the downstream processing unit, directly or through some processing (e.g., processing in a cracker, a hard-wax trap, a gas preheater, or the like, or a combination thereof). As used herein, downstream or upstream can indicate the direction in which a liquid and/or gas product flows; downstream can indicate where the liquid product and/or gas product flows to, while upstream can indicate where the liquid product and/or gas product comes from.

The free nitrogen (N₂) from the air can be relatively unreactive with the carbon-containing feedstock, and can mostly remain as free nitrogen in the producer gas. Air is 78 mol. % N₂. The free nitrogen can account for at least 15 mol. %, or at least 20 mol. %, or at least 25 mol. %, or at least 30 mol. %, or at least 35 mol. %, or at least 40 mol. %, or at least 45 mol. %, or at least 50 mol. % of the producer gas. The free nitrogen can account for 30 mol. %, or 35 mol. %, or 40 mol. %, or 45 mol. %, or 50 mol. % of the producer gas. Typically, conventional F-T GTL and BTL systems can separate most or all of the free nitrogen in the producer gas using an air separation unit and can send the purified producer gas (usually called syngas) to an F-T reactor. However, it has been found that separating the free nitrogen may not be needed, and that the unpurified producer gas can be sent directly to the F-T reactor. The producer gas can be sent directly to a Fischer-Tropsch (F-T) reactor without first passing the air used in gasification through an air separation unit to eliminate the free nitrogen. It has been found that the free nitrogen in the producer gas does not interfere with the functioning of the Fischer-Tropsch catalyst, and can stabilize the production rates of the FTS products by acting as a temperature moderator. The heat capacity of the free nitrogen can also allow larger diameter F-T reactors (e.g., 5 to 8 inches in diameter versus 1 inch for convention F-T reactors) without concerns of runaway temperatures during operation. As used herein, an FTS product can refer to a product generated in an F-T reaction. It can include, for example, a liquid transportation fuel product, a larger hydrocarbon (e.g., a wax), a light olefin, or the like, or a combination thereof.

In some embodiments, an F-T reactor can include a catalyst, wherein the catalyst can be operable to catalyze an FTS reaction. The catalyst can include a transition metal and/or transition metal oxide based material such as iron and/or an iron oxide. Examples of an iron-containing mineral that can be used in the catalyst include, for example, magnetite and hematite, among other minerals. The catalyst can also be selected and/or treated so that it can also catalyze an in-situ water-gas-shift (WGS) reaction (see Reaction 2) between H₂O and CO to tip the ratio of CO:H2 towards 1:2. For example, when the catalyst for the FTS reaction includes an iron containing catalyst, it can be treated or promoted with a copper or potassium promoter (or a Group 1 metal) that can catalyze the WGS activity. The catalyst can be exposed to a reducing atmosphere to activate F-T reaction sites on the catalyst. The iron catalyst may be reduced with hydrogen at pressures of about 50 to about 70 psig and temperatures from about 500° C. to about 550° C. for up to about seven days. The iron catalyst may also be converted to an active FT catalyst by exposure to CO, syngas, or producer gas at temperatures of about 180° C. to about 270° C. and at pressures of less than about 100 psig for up to about five days.

In some embodiments, the iron catalyst comprises volcanic sand. In preferred embodiments, the iron catalyst is a titanomagnitite derived from volcanic sand, for example, titano-magnetic black iron sand. In embodiments, the iron catalyst comprises volcanic sand, wherein the volcanic iron sand comprises at least 40% iron; alternatively, at least 50% iron; or alternatively, at least 60%/iron. The selection and use of the iron catalysts described herein greatly reduces the cost of operating the present system and methods without compromising the ability to achieve the desired end-product or the efficiency of the present system and methods.

In some of the embodiments, the processing unit can include a cracker. In some embodiments, the system can include more than one processing unit, wherein at least one of the processing units can include a cracker. The cracker can crack a larger hydrocarbon (e.g., a wax) into a fluid transportation fuel product, and/or can condense an unsaturated carbon-carbon bond in, for example, a light olefin to produce an alkyl substituted aromatic fluid transportation fuel product. The cracking process can reduce the amount of a larger, waxy hydrocarbon FTS product from, for example, 20 wt. % to less than 5 wt. %. A similar cracker can be used in the product upgrading unit described below.

In some embodiments, a cracker in a processing unit can include a cracking catalyst. The cracking catalyst can include, for example, a ZSM-5 synthetic zeolite (e.g., HZSM-5). A zeolite that is commercially available as a generic commodity product can be used. For example, a suitable zeolite used in some embodiments of the system can include H-ZSM-5 from Zeolyst International. A similar cracking catalyst can be used in the product upgrading unit described below.

In some embodiments, the processing unit can include a hard-wax trap that can be fluidly coupled to the F-T reactor and the cracker. In some embodiments, the system can include more than one processing unit, wherein at least one of the processing units can include a hardwax trap. At least a portion of the first residue and/or at least a portion of the second residue can be delivered to the hard-wax trap. The first residue and/or the second residue can include a hard wax product. The hard-wax trap can be operable to separate and/or recover an additional amount of the liquid transportation fuel product from the hard wax product in the first residue and/or second residue, thereby generating a mixture. The mixture can include, for example, an FTS product other than the liquid transportation fuel product. The mixture can include, for example, a gas, a wax, or the like, or a combination thereof. In some embodiments, the hard-wax trap can capture one or more hydrocarbon waxes that can make up part of the FTS product. In some embodiments, the hard-wax trap can be configured for the recovery of at least some of the wax, which can also be a useful FTS product. If the system includes more than one processing unit, the mixture generated in the hard-wax trap in an upstream processing unit can be included in the feed gas for the downstream processing unit. The mixture generated in the hard-wax trap in the last processing unit or the only processing unit of the system can be included in the product gas delivered to the product upgrading unit.

In some embodiments, the processing unit can include a gas preheater. In some embodiments, the system can include more than one processing unit, wherein at least one of the processing units can include a gas preheater. The gas preheater can preheat the feed gas before it is delivered to the F-T reactor.

In some embodiments, the processing unit can include a soft-wax trap. In some embodiments, the system can include more than one processing unit, wherein at least one of the processing units can include a soft-wax trap. The soft-wax trap can be fluidly coupled to, for example, a gas preheater and/or an F-T reactor. The soft-wax trap can be operable to separate and/or recover an additional amount of the liquid transportation fuel product from a preheated feed gas (e.g., a preheated producer gas, a preheated feed gas from an upstream processing unit, or the like) and can generate at least a portion of the preheated feed gas to be converted in the F-T reactor and/or an amount of the liquid transportation fuel product. This can help to collect more liquid transportation fuel product, and can reduce the amount of the feed gas for further processing (e.g., in an F-T reactor or any other downstream apparatus), thereby increasing the efficiency of the system.

In some embodiments, the system can include more than one processing unit. They can be referred to as a first-stage processing unit, a second-stage processing unit, a third-stage processing unit, or the like. The processing units can be fluidly coupled with one another. Merely by way of example, the system can include two or more processing units in series fluid connection.

Some liquid transportation fuel product can be generated in a processing unit. The amount of the intermediate product (including, for example, at least a portion of the first residue from an F-T reactor, at least a portion of the second residue from a cracker, the mixture from a hard-wax trap, or the like, or a combination thereof) exiting a processing unit that can be fed to a downstream processing unit, can decrease, compared with the feed gas entering the processing unit. The needed capacity of a downstream processing unit can be smaller than an upstream one. This can be satisfied in different ways. In some embodiments, the capacity of the processing units can be different, wherein the capacity of a downstream processing unit can be smaller than that of an upstream one. In some embodiments, more than one upstream processing unit can be in parallel arrangement, which can be fluidly coupled to a downstream processing unit in series.

In some embodiments, the product upgrading unit can be operable to produce an additional amount of the liquid transportation fuel product from a product gas. The product upgrading unit can be operable to improve one or more property of the liquid transportation fuel product generated in the processing unit(s) and/or product upgrading unit(s) of the system.

In some embodiments, the product gas can include at least a portion of the first residue and/or at least a portion of the second residue from the processing unit(s). In some embodiments, the product gas can include the mixture generated in a hard-wax trap in at least one of the processing units.

The product upgrading unit can include at least one apparatus selected from the group consisting of, for example, a condenser, a hydrogenation apparatus, a distillation apparatus, an isomerization apparatus, a molecular-sieve polishing apparatus, an activated-carbon polishing apparatus, a hydrogen membrane, and the like. The product upgrading unit can generate a third residue. The third residue can include, for example, a gas, hydrogen, vapor, a wax, or the like, or a combination thereof. The third residue can be recycled for further processing in, for example, a processing unit. In some embodiments, the third residue can pass through a bed of activated carbon to recover a light hydrocarbon gas, and the reminder can be used to fuel, for example, an internal combustion engine or other applications.

In some embodiments, some of the FTS product generated by the F-T reactor(s) in the processing unit(s), some of the cracked hydrocarbon product generated by the cracker(s) in the processing unit(s), and/or the liquid transportation fuel product can be hydrogenated in a hydrogenation apparatus to produce a stabilized fluid transportation fuel product having an enhanced heating value and/or aging characteristics. The hydrogenation apparatus can include a hydrogenation catalyst that can catalyze the reaction of molecular hydrogen (H₂) in the producer gas with an unsaturated carbon-carbon bond in the FTS product (cracked and/or uncracked) to produce less unsaturated or fully saturated fluid transport fuel product. When the F-T catalyst in the F-T reactor(s) can catalyze a WGS reaction, enough molecular hydrogen can be generated so that additional outside source of hydrogen may not be needed for the hydrogenation reactor.

The hydrogenation catalyst can include, for example, a palladium-containing catalyst, a platinum-containing catalyst, or the like, or a combination thereof. Exemplary catalysts can include, for example, 0.5% palladium on alumina, or the like, or a combination thereof. The hydrogenation catalyst can be commercially available from, for example, Aldrich Chemical Company (Aldrich No. 520675).

In some embodiments, the liquid transportation fuel product can be treated in an isomerization apparatus. The isomerization apparatus can include an isomerization catalyst, for example, a ferrierite zeolite catalyst, to convert a straight-chained hydrocarbon to a branched-chained hydrocarbon to lower the freezing point.

In some embodiments, the liquid transportation fuel product can meet a commercial-fuel specification, for example, after the addition of one or more usual fuel additives, so that it can be used as direct replacement for a commercial fuel.

Some embodiments of the application include a method for converting a carbon-containing feedstock into a liquid transportation fuel product using the system described herein. The method can include adding one or more usual fuel additives. The liquid transportation fuel product generated using the method can meet a commercial-fuel specification, for example, after the addition of one or more usual fuel additives, so that they can be used as direct replacement for a commercial fuel.

Some embodiments of the application include a method for converting a carbon-containing feedstock into a hydrocarbon wax. The method can include converting the carbon-containing feedstock into a producer gas including, for example, H₂, CO, CO₂, and N₂; reacting the producer gas with a substrate catalyst to a FTS product, the FTS product can include a hydrocarbon gas, a liquid, and a first portion of the hydrocarbon wax, and reacting at least a portion of the hydrocarbon gas and liquid with the substrate catalyst to produce a second portion of the hydrocarbon wax.

### EXAMPLES

The following non-limiting examples are provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

It is understood that the operation parameters indicated in the following examples are for illustration purposes only, and are not intended to limit the scope of the application. It is understood that different combinations of these and other relevant operation parameters can be used to achieve the same or similar function(s), and are covered by the application.

### Example 1

### Train of Processing Units

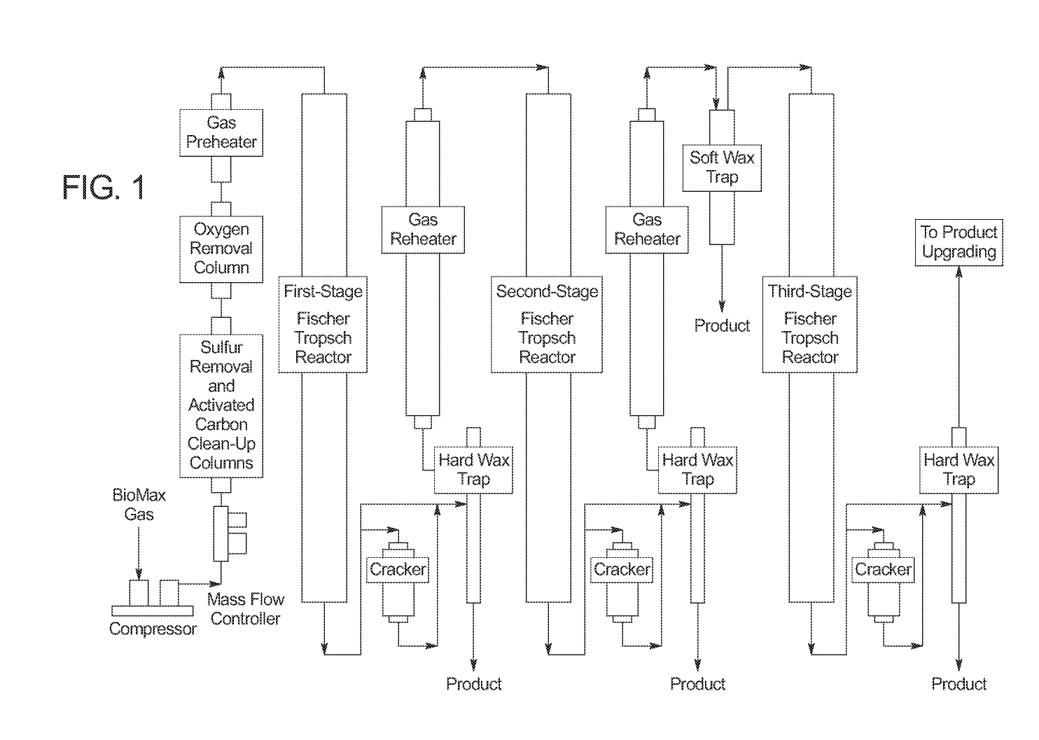

FIG. 1 illustrates a part of an exemplary system including three processing units in fluid connection in series. The illustrated part includes a train of LIQUIMAX® F-T reactors. Producer gas can be generated in a gasification reactor (not shown in FIG. 1). Approximately 70 Nm³/hr of producer gas from the BIOMAX® or Methane Reformer can be compressed up to 400 psig with two 2-stage compressor systems. Prior to compression, the gas can be sent through a knock-out drum to remove entrained water and packed beds of activated carbon and “Sulfatreat” to remove tars and hydrogen sulfide. A 2-stage compressor system can include a modified Ingersoll Rand (IR) air compressor and a Blackmer reciprocating compressor. Treated gas can be compressed to 200 psig in the IR air compressor. From the IR compressor, the producer gas can be transferred to the Blackmer reciprocating compressor where it can be compressed to 385 psig and stored in a surge receiver. The compressed producer gas can pass through a mass flow controller, sulfur removal and activated carbon clean-up columns, and then an oxygen removal column. Before the producer gas is fed to the first-stage F-T reactor, it is preheated in a gas preheater.

The compressed (and cleaned) producer gas can be transferred to the LIQUIMAX® FTS module where it can be converted to liquid fuel products. A schematic of the LIQUIMAX® module is provided in FIG. 1. For the FTS and WGS operations, the LIQUIMAX® can employ a proprietary fixed-bed BTL catalyst system that can operate at relatively low pressures (between 185 and 310 psig), making this process more amenable to small distributed modular applications. A BTL catalyst developed in-house described in Example 3 can be used in the reactor to catalyze both the FTS reaction and the WGS reaction.

Unlike traditional FTS catalysts that convert extensively polished syngas (containing only CO and H₂) to a high molecular weight wax, the LIQUIMAX® FTS catalyst can be designed specifically to take advantage of a higher nitrogen content (e.g., 30 vol %, or 35 vol %, or 40 vol %, or 45 vol %, or 50 vol %, or higher than 50 vol % of the producer gas or feed gas delivered to a reactor) in the BIOMAX® or methane reformer producer gas to improve or maximize yields of liquid transportation fuels for on-site use. As with other FTS systems, however, the LIQUIMAX® system can produce a wide variety of products including a light hydrocarbon gas (e.g., methane, ethane, propanes, butane, or the like, or a combination thereof), a light olefin (e.g., ethylene, propylene, butylene, or the like, or a combination thereof), a gasoline, a kerosene, a jet fuel, a diesel fuel, a wax, or the like, or a combination thereof.

The exemplary sub-system shown in FIG. 1 includes three processing units in series fluid connection. A processing unit can include a gas preheater, an F-T reactor, a cracker and a hard wax trap. The sub-system can produce a liquid transportation fuel product, and a product gas for further processing in the product upgrading unit.

### Example 2

### Setup for Upgrading Product Gas and Liquid Transportation Fuel Product

A raw liquid transportation fuel product and/or a product gas from the BTL reactor (e.g., LIQUIMAX® module exemplified in FIG. 1) can be sent through a packed bed of a commercial zeolite cracking catalyst to convert the high molecular-weight wax product to a liquid fuel and condense the light olefin to methyl and ethyl substituted aromatic gasoline and diesel constituents. A synthetic zeolite (H-ZSM-5) catalyst can be used to crack the wax(es) and aromatize light olefin(s). The ZSM-5 catalyst technologies were developed by Mobil Oil Company (Mobil) in the 1970s to crack heavy oils (including FTS waxes) and convert methanol to aromatic gasoline constituents. Today the catalyst is commonly used in refinery operations and is available as a generic commodity product. Raw Fuel Upgrading

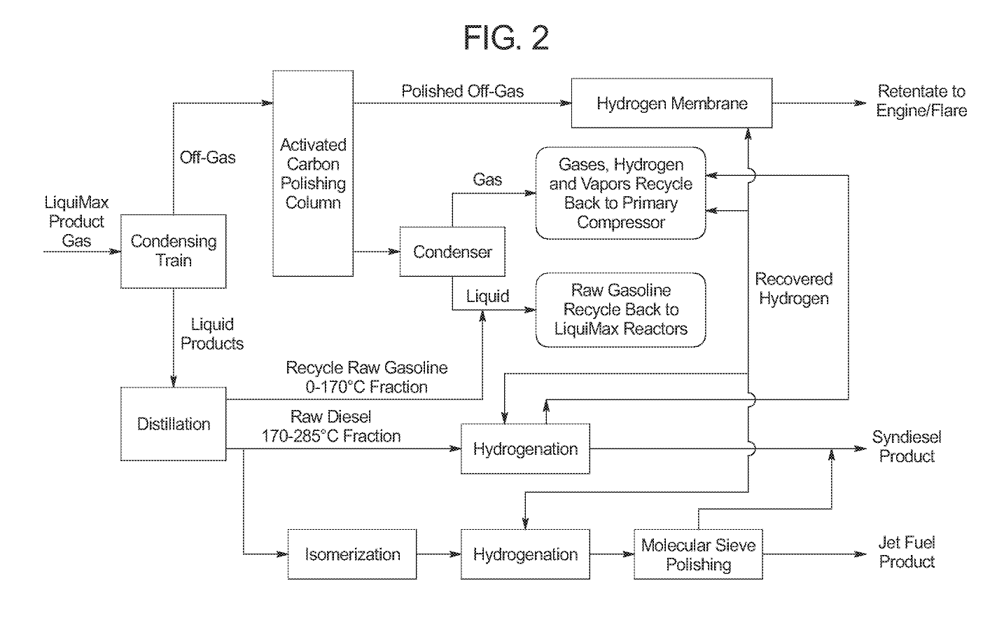

A raw synthetic liquid transportation fuel product and/or a product gas from the LIQUIMAX® module can be processed through a series of upgrading operations where the liquid fuel can be converted to, for example, No. 1 diesel and/or a jet fuel product. A gas can be treated to recover a light hydrocarbon vapor and hydrogen for recycle to the front end of the LIQUIMAX® module. A schematic of the fuel upgrading system (product upgrading unit) is provided in FIG. 2. The unit can include, for example, a downstream cracking apparatus, an isomerization apparatus, a hydrogenation apparatus, or the like. These apparatus can be designed to convert an unwanted wax and/or light olefin to a stable gasoline, aviation, and/or diesel fuel product.

The product stream from LIQUIMAX® operations can be processed through a series of chilled water tube-in-shell heat exchangers where a condensable liquid can be separated from a primary off-gas stream (containing mostly light hydrocarbon(s), carbon monoxide, carbon dioxide, hydrogen and nitrogen). The liquid stream can be fractionated in a batch- or a continuous-distillation unit to produce a raw gasoline product, a raw diesel fuel product, and/or a wax product. The primary off gas can be processed through an adsorption column to recover light hydrocarbon(s) and gasoline-type liquid product(s) and a hydrogen recovery system.

### Primary Off-Gas Polishing

Activated Carbon Adsorbent Columns

Off-gas from the condensing system can be processed though fixed-bed columns of activated carbon (Calgon VPR 4×10 activated carbon) where light hydrocarbon gas(es) and gasoline-range liquid(s) can be adsorbed. Merely by way of example, after three hours, the flow can be switched to the second activated carbon column, −23 inches Hg vacuum pulled in the first column, and the column heated to 180° C. to 200° C. for 2 hours. The effluent from the vacuum pump can be sent though a cryogenic condenser (where C5 to C9 hydrocarbon(s) can be recovered) and non-condensable gas(es) can be sent to the suction-side of the primary system condenser. Recovered C5 to C9 liquid product(s) can be injected in the top of the 3^{rd}-stage F-T columns (the F-T reactor in the third-stage processing unit exemplified in FIG. 1) where they can be converted to a higher molecular-weight diesel product and/or wax product.

Hydrogen Recovery Membrane

The hydrocarbon depleted gas from the activated-carbon adsorption system can be sent through a Membrane Technologies Research (MTR) “HyFlow” hydrogen-selective membrane where hydrogen can be extracted and recycled to the front end of the LIQUIMAX® system or can be used in the hydrogenation process of a liquid product upgrading system. The hydrogen/hydrocarbon depleted gas from the MTR membrane can be used to fuel an internal combustion engine or flared.

Liquid Product Upgrading

A liquid LIQUIMAX® product (an FTS product) can be collected in a condensing train, composited daily, and processed in a batch- or a continuous-distillation system to produce a raw gasoline (0-170° C.) fraction, raw diesel (170° C.-285° C.), and solid wax (285° C.+).

Raw Gasoline Processing

The raw gasoline can contain highly olefinic (FT-active) straight-chain and branched hydrocarbons and a minor amount of aromatic constituent(s). This stream can be mixed with the liquid product(s) from the activated-carbon adsorption system (discussed in the previous section) and recycled to the third-stage FT columns (the F-T reactor in the third-stage processing unit exemplified in FIG. 1) of the LIQUIMAX® module where it can be converted to liquid product(s). The raw gasoline can also be converted to a liquid transportation fuel product by processing through an isomerization apparatus, a hydrogenation apparatus, a normal hydrocarbon removal system, or the like, or a combination thereof.

### Raw Diesel Processing

Raw diesel from the distillation system can be converted to, for example, a low-sulfur No. 1 Syndiesel or a jet fuel product.

Production of Syndiesel

The raw diesel fraction can include straight-chain olefinic hydrocarbon(s) with a minor amount of branched olefin(s) and aromatic(s). The raw diesel can be hydrogenated with hydrogen from the MTR system (discussing in the Primary Off-Gas Polishing section) in a fixed bed column of platinum catalyst.

Production of Jet Fuel

To manufacture a jet fuel (e.g., JP-8), the raw diesel fraction for the batch distillation system can be processed through a proprietary isomerization system where straight chain olefin(s) can be converted to a highly-branched constituent. An isomerization product can be hydrogenated, and processed through a molecular-sieve column to produce a low freezingpoint jet fuel.

Isomerization

A proprietary catalytic isomerization process can be used to convert a straightchain olefin to a branched olefin with a lower freezing point. The isomerization catalyst can include a ferrierite-type zeolite that can be mixed with a Boehemite Phase Alumina binder, extruded to ⅛″ diameter cylinders (a cylinder of a different size and/or shape can also be used) and calcined at 625° C. The calcined product can be packed in a fixed bed reactor at raw dieselrange unhydrogenated product processed at temperatures of 300° C. to 400° C. and 100 to 200 psi. It is understood that the temperature at which calcination is performed, as well as other operation parameters, can be chosen based on considerations including the properties of the composition(s) to be processed. The calcination temperature, as well as other operation parameters, illustrated above is for illustration purposes only, and is not intended to limit the scope of the application.

Hydrogenation

Products from the isomerization process can be hydrogenated in the process described in “Production of Syndiesel” section above. Alternatively, the liquid products can be hydrogenated during isomerization.

Molecular-Sieve Polishing

In the final process step of jet fuel production, hydrogenated isomerized product can be treated in a MS-5A molecular sieve column to remove residual normal (straight-chain) alkanes to lower the freeze point of the fuel.

### Example 3

### Summary of Exemplary LiquiMax® Process

Disclosed in the application includes distributed generation, automated, modular, gasifier systems. The capability of the BioMax® gasification module can include conversion of cellulosic biomass feedstocks into hydrocarbon liquid transportation fuels. The modular LiquiMax® technology can provide a distributed micro-biorefinery capable of producing synthetic diesel and gasoline for on-site and local use, thus displacing conventional fossil liquid fuels.

Commercial Gas-to-Liquid (GTL) systems can be based on a multiplicity of complex refinery-based operations using oxygen-blown conversion of natural gas or other fossil fuel-based resources into synthesis gas (syngas) containing hydrogen (H₂) to carbon monoxide (CO). The syngas can be converted into liquid hydrocarbon fuels and waxes through a series of Fischer-Tropsch Synthesis (FTS) reactions using either a cobalt- or iron-based catalysts:

nCO+2nH₂ [symbol] -{CH₂}ₙ-+nH₂O (Reaction 1: FTS)

From this reaction, each molecule of CO can react with two molecules of H₂ to produce hydrocarbon products (liquid fuels and waxes) and one molecule of H₂O (water). In Biomass to Liquid (BTL) systems, the gasification of biomass produce a hydrogen-deficient syngas (containing approximately a 1:1 molar ratio of CO:H₂) that may not sustain the FTS reactions. For these systems, CO:H₂ ratio can be adjusted through a Water-Gas-Shift (WGS) reaction that can convert a portion of the CO in the feed gas to H₂ and CO₂:

CO+H₂O [symbol] H₂+CO₂ (Reaction 2: WGS)

The WGS reaction can be catalyzed by iron-based FTS catalysts and approximately one-half of the CO in the gas can react with an equal molar amount of water (from the FTS reaction) to produce H2 and CO2. The remaining CO can be converted to FTS products.

2nCO+nH2 [symbol] -{CH2}ₙ-+nCO₂ (Reaction 3: Overall)

The conventional wisdom is that a small biorefinery would be expected to have poor economics. However, a small-scale biorefinery can allow the use of low, or even negative cost feedstocks, at their source, thereby reducing or eliminating transportation and distribution costs. By using this paradigm in conjunction with a greatly simplified conversion process, and locating the system where competing delivered fuel prices are high, distributed, cost effective, small-scale biorefineries can become feasible.

Merely by way of example, the LiquiMax® technology can focus on coupling small modular liquid-fuel processing units with automated air-blown BioMax® gasifiers for onsite generation of liquid fuels. This process can convert producer gas (a nitrogen-diluted syngas containing, for example, 50 vol % N₂, 20 vol % CO, 20 vol % H₂, and 10% CO₂) made from low cost organic residues, directly to liquid-fuel products (gasoline, diesel or jet fuels) in a unique two-stage, single-pass system.

### Example 4

### Exemplary BTL Catalyst

For the FTS and WGS operations, the LiquiMax® can employ proprietary fixedbed BTL catalyst systems that can operate at relatively low pressures (between, for example, 180 and 380 psig), making this process more amenable to small distributed modular applications.

A BTL catalyst was developed in-house using an inexpensive iron-mineral substrate. The catalyst was used to catalyze both the FTS reaction and the WGS reaction in the same F-T reactor. In a series of steps, a Group 1 metal (as a promoter and/or a catalyst) were added to the iron-containing catalyst substrate to adjust the WGS characteristics and distribution of liquid fuels in the product stream and reduced with hydrogen to generate active sites on the surface of the mineral. The catalyst precursor was reduced with recirculating hydrogen at a temperature of 350° C. to 650° C. and pressure of 50 to 250 psig. This process produces water and continues until no water is generated (approximately one week). In a final series of steps, catalytic-active carbon is deposited on the reduced mineral. The hydrogen-reduced precursor was treated with either CO or producer gas at pressures of 15 to 250 psig at a temperature of 250° C. to 320° C. This process produced CO₂ and continued until the system stopped generating CO₂ (approximately 3 days).

### Example 5

### Exemplary BTL Catalyst

The mineral substrate can include a titano-magnetic black sand. Such sand is available from, for example, Indonesia, New Zealand, Costa Rica, etc. Merely by way of example, the ore particles of the sand from New Zealand Steel Corporation have a spheroidal (beach sand) shape and size distribution of the as-received sand is provided in Table 1.

TABLE 1
Particle Size Distribution of As-Received New Zealand Sand

| Size | Screen | As Received | | |
|---|---|---|---|---|
| mm | Size | Weight | % | Retained |
| 0.18 | Plus 80 | 0.5 | 7.04% | 7.04% |
| 0.15 | 80 × 100 | 1.2 | 16.90% | 23.94% |
| Minus | Minus | 3.4 | 47.89% | |
| 0.125 | | | | |

Merely by way of example, described below is an exemplary process to make the catalyst using the sand from New Zealand Steel Corporation. It is understood that the exemplary process described herein, including the source of the sand and the parameters of the exemplary process, is provided for illustration purposes, and is no intended to limit the scope of the application.

In preparation of the catalyst, a portion of the as-received black sand was mixed with approximately 1 weight percent copper powder and the sandicopper mixture was pulverized at Hazen Research, Inc. (Golden, Colo.). The sand/copper was pulverized in a ball mill to a size of minus 200 mesh (less than 0.074 mm) and blended to assure dispersion of the copper in the pulverized black sand matrix. Copper was added to the sand as a metal to reduce or eliminate the need for a drying process that may be needed in the case that copper was added in the form of a water-soluble copper compounds. Copper was added to increase the WGS characteristics of the catalyst.

As-received and pulverized sand-copper mixture was sent to Feeco International (Green Bay, Wis.) where the mixture was agglomerated in a pin mixer/pan agglomerate to a particle size of 2 Mesh ( 7/16″)-by-6 Mesh ( 3/16″). Feed rates to the agglomeration system of the pellets was:

400 lbs/hr as-received New Zealand Ore (no copper added)-effective catalyst;

145 lbs/hr internal recycle minus 3/16″ fines from the agglomeration process-effective catalyst;

200 lbs/hr fines (from Hazen with copper added during pulverization)-assist in binding of pellets;

50 lbs/hr Bentonite (Black Hills Bentonite: Unaltered Wyoming Sodium Bentonite)-provide tackiness for growth of pellets:

29 lbs/hr to pin mixer and 72 lbs/hr to pan agglomerater silicate solution (2 parts Kasil-1 (PQCorporation) to 1 part water to produce a 19% solids solution)-binding agent.

The composition of the as-received black sand and pelletized products is provided in the following table.

TABLE 2
Composition of Raw Iron Sand and Pelletized Catalyst (Wt. %)

| Material | Fe(Total) | CaO | SiO2 | TiO2 | Al2O3 | MgO | P | V2O3 | MnO | Cu | Cr | Zn | Na2O | K2O |
|---|---|---|---|---|---|---|---|---|---|---|---|---|---|---|
| Sand | 59.92 | 0.32 | 1.58 | 8.10 | 3.71 | 2.70 | 0.03 | 0.50 | 0.63 | <0.005 | 0.04 | 0.07 | <0.07 | 0.04 |
| Pellet | 54.58 | 0.45 | 7.12 | 7.41 | 4.08 | 2.55 | 0.03 | 0.45 | 0.58 | 0.20 | 0.04 | 0.06 | 0.09 | 1.39 |

Preparation of the catalyst can be a three-stage process: catalyst reduction, activation, and induction.

### Catalyst Reduction

In the initial catalyst preparation step, pelletized catalyst was packed into a 5- or 7-inch diameter FT reactor (described in the previous section), sealed and placed in a clam-shell furnace. The reactor was heated to an internal temperature of 500 to 550° C. under a recirculating hydrogen stream. The temperature of the reduction step was limited to 550° C. to limit fusing of the catalyst and degradation of the silica binding agent. During the reduction period (about 7 days), the hydrogen pressure was maintained at 50 to 70 psig and, at these pressures, the rotometer for the recirculating hydrogen set at 8 liters/min. Pressure was limited to less than 75 psig to maintain low partial pressures of water product which can oxidize with previously reduced catalyst sites. Off gas from the reactor was processed through a chilled condenser and drierite column to remove water before recycling. After 7 days, the catalyst lost between 8 to 10% weight from the reduction of magnetite (Fe₃O₄) to a mixture of FeO and Fe. The reduction stage was continued until a weight loss of at least 8 percent was achieved. Weight loss was determined by weighing the column before and after reduction. For the black sand matrix, the complete conversion of magnetite (Fe₃O₄) to ferrous oxide (FeO) represented a weight loss of approximately 7%, so a loss of 8 to 10% would indicate some conversion to elemental iron (Fe).

### Activation of Catalyst

During catalyst activation, FeO and Fe (from the reduction of magnetite) were converted to FT-active Hagg iron carbide (Fe₅C₂) by treating the reduced column with CO. For activation, a reactor containing reduced catalyst was flushed with nitrogen (to remove residual hydrogen from the reduction), heated to 270 to 280° C. with recirculating oil, and treated with CO at a flow rate to 10 SLPM at 0-10 psig. As the CO₂ level in the off-gas fell to less than 10%, the CO flow was decreased to 5 SLPM to reduce CO usage, and the flow was reduced again to 2.5 SLPM as the CO₂ concentration fell below 7%. After 24 hours, the pressure was increased to 75-100 psig and activation continued at a CO flow of 2.5 SLPM for an additional 48 hours. The column was then flushed with nitrogen to remove residual CO.

### Induction for FT Products

To initiate production of FT products, the activated catalyst was treated with syngas to start (induce) hydrocarbon-forming polymerizing reactions on the active Fe5C2. During the induction process, a train of 3 FT reactors was treated with syngas from a syngas generator (containing approximately 18% CO, 28% H₂, 4% CO₂, 1% CH₄ and 48% N₂) at a flow rate of 350 to 450 SLPM (21 to 27 Nm/hr) through each reactor train and a pressure around 120 psig. The initial temperatures in the reactors was around 250° C., after reaching steady state operations, the temperature was adjusted to maintain a maximum reactor temperatures around 300° C., pressure was increased by 50 psig increments every 12 hours until a feed pressure of 300 psi was achieved and the system was allowed to run for an additional 3 to 5 days to complete the induction process.

### Production of Raw Liquid Fuel Products

Gasoline vapors were produced within the first 12 hours of induction. By the end of the 5-day induction period, the entire range of FT products was produced from light olefin gases to waxes. Raw liquid fuel products were produced from the two FT trains in the LiquiMax module. Each train included three FT reactors. A fixed-bed cracking reactor (containing commercial ZSM-5 cracking catalyst) was placed after each FT reactor to crack high molecular weight products to liquid fuel intermediates and convert low molecular weight olefins (ethene, propene, and butene) to diesel-fuel range aromatics (alkyl substituted benzene).

### Example 6

### Liquid Transportation Fuel Generation

As disclosed herein, various liquid transportation fuels may be produced through practicing the present methods with corresponding system. Different liquid transportation fuels may produced from the same starting materials. Two exemplary liquid transportation fuels include ultra low sulfur diesel gasoline and jet fuel.

In this example, Lodgepole Pine wood chips (Rocky Top Resources Inc. Colorado Springs, Colo.) were processed through the BioMax gasification system generating a producer gas containing approximately 21 vol % carbon monoxide (CO), 17 vol % hydrogen (H₂), 12 vol % carbon dioxide (CO₂), 48 vol % nitrogen (N₂), and 2 vol % methane (CH₄). Producer gas was fed to the LiquiMax system at pressures of 250 to 300 psig and approximately 300 SLPM through each of the two F-T reactor trains. The temperature of the heat transfer oil to each reactor was adjusted to achieve center-line temperature profiles of between 280° C. and 325° C. Subsequent CO conversion was between 48 and 55 percent. The distribution of distilled products is recited in Table 3.

TABLE 3
Composition of Raw Product

| Raw Product (Distillation range) | Distribution, Vol % |
|---|---|
| Gasoline (Ambient to 170° C.) | 39.8 |
| Diesel (170 to 285° C.) | 51.8 |
| Heavy Liquid and Wax (+285° C.) | 19.2 |

### Ultra Low Sulfur Diesel Gasoline

Ultra low sulfur diesel gasoline can be produced through use of the present system and methods. In particular, ultra low sulfur diesel gasoline may be produced through hydrogenation of the raw diesel product distillation fraction from Lodgepole Pine wood chips. Certain physical and chemical characteristics of an ultra low sulfur diesel gasoline product made from the raw product described in Table 3 using the present system and methods is described in Table 4.

TABLE 4
Characteristics of Ultra Low Sulfur Diesel Gasoline Made from the Present
System and Methods

| | | Syndiesel from | | |
|---|---|---|---|---|
| | | Lodgepole | | |
| | ASTM D975-13 | Pine Chips | | |
| | Ultralow Sulfur | | Meets ASTM | |
| | No. 1 Diesel | | No. 1 Diesel | ASTM |
| Parameter | Standard | Value | Standard | Method |
| Flash Point. ° C. | 38° C. Min | 59 | ✓ | D93 |
| Water and Sediment, Vol % | 0.05 Vol % Max | <0.005 | ✓ | D2709 |
| Sulfur, ppm mass | 15 ppm | 1.6 | ✓ | D5453 |
| Distillation | | | | |
| Initial Boiling Point, ° C. | | 167.9 | | D86 |
| Evap 5, ° C. | | 180.8 | | |
| Evap 10, ° C. | | 185.1 | | |
| Evap 15, ° C. | | 187.6 | | |
| Evap 20, ° C. | | 190.9 | | |
| Evap 30, ° C. | | 197.5 | | |
| Evap 40, ° C. | | 203.3 | | |
| Evap 50, ° C. | | 210.1 | | |
| Evap 60, ° C. | | 217.9 | | |
| Evap 80, ° C. | | 237.2 | | |
| Evap 90, ° C. | 288° C. Max | 251.4 | ✓ | |
| Evap 95, ° C. | | 261.3 | | |
| Final Boiling Point, ° C. | | 272.9 | | |
| Recovered, mL | | 98.1 | | |
| Residue, mL | | 1.1 | | |
| Loss, mL | | 0.8 | | |
| Composition, Vol % | | | | |
| Aromatic | 35 Vol % Max | 10.9 | ✓ | D1319 |
| Olefins | | 0.9 | | |
| Saturated | | 88.2 | | |
| Specific Gravity | | 0.7787 | | D4052 |
| Measured Cetane Index | 40 Min | 64.1 | ✓ | D6890 |
| | | 63.7 | ✓ | D613 |
| Cloud Point/Pour Point, ° C. | Variable | −26.9 | ✓ | D5773 |
| | Depending on | | | |
| | location and 10th | | | |
| | percentile | | | |
| | minimum | | | |
| | temperatures. In | | | |
| | Denver, Colorado, | | | |
| | the coldest 10th | | | |
| | percentile is −19° C. | | | |
| | and occurs in | | | |
| | January | | | |
| Ramsbottom Carbon Residue | 0.15 wt % Max | 0.05 | ✓ | D524_10% |
| on 10% Distillation Residue | | | | |
| Copper Corrosion, 3 hours at | No. 3 Max | 1A | ✓ | D130 |
| 50° C. | | | | |
| Ash, wt % | 0.01 wt % Max | <0.001 | ✓ | D482 |
| Kinematic Viscosity, mm2/s @ | 1.3 to 2.4 | 1.4 | ✓ | D445 40c |
| 40° C. | | | | |
| Lubricity HFRR, mm | Wear Scar 0.520 mm | Wear Scar | ✓ | D6079 60c |
| | Max | 0.503 | | |
| | | Major Axis | | |
| | | 0.562 | | |
| | | Minor Axis | | |
| | | 0.443 | | |
| | Description | Evenly | | |
| | | Abraded | | |
| | | Oval | | |
| Biological Carbon, % | | 100 | | D6866-12 |
| Gross Heat of Conbusion BTU/lb | | 20,057 | | D240 |

As shown by Table 4, the raw product described in Table 3 can be transformed through the use of the present system and methods into a liquid transportation fuel that qualifies as ultra low No. 1 diesel gasoline. Although the data is not shown, a liquid transportation fuel that qualifies as ultra low No. 2 diesel gasoline has also been produced through use of the present system and methods.

### Jet Fuel

Jet Fuel can be produced through use of the present system and methods. In particular, jet fuel may be produced through hydrogenation, isomerization and polishing the raw diesel product distillation fraction from Lodgepole Pine wood chips as described herein. Certain physical and chemical characteristics of a jet fuel product made from the raw product described in Table 3 using the present system and methods is set forth in Table 5.

TABLE 5
Characteristics of Jet Fuel Made from the Present System and Methods

| | | | ASTM D7566-13 | |
|---|---|---|---|---|
| | | ASTM D7566-13 Batch | Requirement for | |
| | | Requirements for a | “Aviation Fuel | |
| | | “Fischer-Tropsch | Containing | JP-8 From |
| | | Hydroprocessed SPN” | Synthesized | Southern |
| | | (ASTM Document | Hydrocarbons” (ASTM | Lodgepole |
| Parameter | ASTM Method | Tables A1.1 and A1.2) | Document Table 1) | Pine |
| Acid, total mg KOH/g | ASTM D3242 | Max 0.015 | 0.1 | 0.017 |

Hydrocarbon Type, vol %

| Aromatics | ASTM D1319 | Require ASTM 2425 | Min 8, Max 25 | 9.2 |
|---|---|---|---|---|
| | | Max 0.5 | | |
| Olefins | | Not Required | | 0.7 |
| Saturates | | Not Required | | 90.1 |
| Naphthalene, Vol % | ASTM D1840 | Not Required | Max 3.0 | 0.34 |
| Sulfur, mercaptan, mass % | ASTM D3227 | Not Required | Max 0.003 | <0.0003 |
| Sulfur total, mass % | Astm D5453 | Max 0.0015 | Max 0.30 | 0.00009 |
| Distillation, ° C. | | | | |
| IBP | ASTM D86 | Not Required | | 151.9 |
| 5% Recovery Temp | | Not Required | | 161.2 |
| 10% Recovery Temp | | Max 205 | | 162.8 |
| 20% Recovery Temp | | Not Required | | 166.7 |
| 30% Recovery Temp | | Not Required | | 171.3 |
| 40% Recovery Temp | | Not Required | | 175.8 |
| 50% Recovered Temp | | Report | | 180.6 |
| 60% Recovered Temp | | Not Required | | 186.1 |
| 70% Recovered Temp | | Not Required | | 192.6 |
| 80% Recovered Temp | | Not Required | | 201.1 |
| 90% Recovered Temp | | Report | | 213.9 |
| 95% Recovered Temp | | Not Required | | 226 |
| Final Boiling Point, Temp | | Max 300 | | 241.2 |
| Distillation Recovered, % | | Not Required | | 98.5 |
| Distillation Residue, % | | Max 1.5 | | 1.1 |
| Distillation Loss, % | | Max 1.5 | | 0.4 |
| Flash Point. ° C. | ASTM D56 | Min 38 | | 46 |
| Density at 15° C., 775 to 840, kg/m³ | ASTM D4052 | 730 to 770 | 775 to 840 | 763 |

| | | |
|---|---|---|
| Calculated Cetane Index | Not Specified | Not Required |

Fluidity

| | | | | |
|---|---|---|---|---|
| Freeze Point, ° C. | ASTM D5972 | Max −40 | Max −47 | −53 |
| Viscosity −20° C., mm2/3 | ASTM D445 | Not Required | Max 8.0 | 2.9 |

Combustion

| | | | | |
|---|---|---|---|---|
| Gross Heat of Combustion, MJ/kg | ASTM D 4809 | Not Required | Not Required | 46.6 |
| Gross Heat of Combustion, BTU/lb | | | | 20,060 |
| Net Heat of Combustion, MJ/kg | | | Min 42.8 | 43.56 |
| Net Heat of Combustion, BTU/lb | | | Min 18,424 | 18,728 |
| Smoke Point, mm | ASTM D1322 | Not Required | Min 25 | 35.5 |

Corrosion

| | | | | |
|---|---|---|---|---|
| Copper strip, 2 hrs at 100° C. | ASTM D130 | Not Required | Max No. 1 | 1a |

Thermal Stability

| | | | | |
|---|---|---|---|---|
| 2.5 hours at Min Temp, ° C. | ASTM D3241 | 325° C. | 260° C. | 260 |

| | | |
|---|---|---|
| Filter pressure drop, mmHG | Max 25 | 58 |
| Tube deposit rating | Max 3 | <1 |

Contaminants

| Existent gum, mg/100 ml | ASTM D381 | Max 7 | | 2 |
|---|---|---|---|---|
| Microseparometer, Rating | ASTM D3948 | Not Required | No Additive, Min 85 | 92 |
| Electrical Conductivity, pS/m | ASTM D2624 | Not Required | None, No Additive | 1 |

Table 5 shows the raw product described in Table 3 can be transformed through the use of the present system and methods into a liquid transportation fuel that qualifies as jet fuel under the initial non-dynamic testing protocols.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein, without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

1. A system for converting a carbon-containing feedstock into a liquid transportation fuel product, the system comprising
an air-blown producer gas reactor operable to convert the carbon-containing feedstock into a producer gas comprising H₂, CO, CO₂, and N₂, with substoichiometeric amounts of H₂ and CO (less than 2:1 molar ratio of H₂ to CO);
a processing unit, wherein the processing unit comprises a Fischer-Tropsch (F-T) reactor, and a cracker,
wherein the F-T reactor comprises an iron catalyst, wherein the iron catalyst comprises volcanic sand,
wherein the F-T reactor is fluidly coupled to a source of feed gas and operable to convert at least a portion of the feed gas into a FTS product, wherein the FTS product comprises the liquid transportation fuel product and a first residue, and
wherein the cracker is fluidly coupled to the F-T reactor and operable to catalytically crack at least a portion of the first residue to produce an additional amount of the liquid transportation fuel product and a second residue; and a product upgrading unit, wherein the product upgrading unit is operable to produce an additional amount of the liquid transportation fuel product from a product gas.

2. The system of claim 1, wherein the carbon-containing feedstock comprises at least one feedstock selected from the group consisting of a ligno-cellulosic biomass solid, a biomass derived oil, a biomass derived gas, and a fossil-fuel derived carbonaceous feedstock.

3. The system of claim 1, wherein the F-T reactor is fluidly coupled to the air-blown producer gas reactor, wherein the feed gas to the F-T reactor comprises the producer gas.

4. The system of claim 1, further comprising a hard-wax trap, wherein the hard-wax trap is fluidly coupled to the F-T reactor and the cracker, wherein at least a portion of the first residue and/or at least a portion of the second residue is delivered to the hard-wax trap, wherein the hard-wax trap is operable to separate an additional amount of the liquid transportation fuel product and a mixture from a hard-wax product.

5. The system of claim 1, wherein the iron catalyst comprises a titanomagnitite.

6. The system of claim 1, wherein the system comprises more than one processing unit, wherein the feed gas of the F-T reactor of at least one of the processing units comprises the producer gas from the air-blown producer gas reactor, wherein the feed gas of the F-T reactor of at least one of the processing units comprises at least a portion of the FTS product generated in another F-T reactor of the system.

7. The system of claim 1, further comprising a soft-wax trap, wherein the soft-wax trap is fluidly coupled to the F-T reactor, wherein the soft wax trap is operable to separate an additional amount of the liquid transportation fuel product from the feed gas.

8. The system of claim 7, wherein at least one of the more than one processing unit comprises a soft-wax trap, wherein the soft-wax trap is fluidly coupled between the gas preheater and the F-T reactor, wherein the soft-wax trap is operable to separate an additional amount of the liquid transportation fuel product from the preheated feed gas.

9. The system of claim 1, wherein the product upgrading unit comprises at least one apparatus selected from the group consisting of a condenser, a hydrogenation apparatus, a distillation apparatus, an isomerization apparatus, a molecular-sieve polishing apparatus, an activated-carbon polishing apparatus, and a hydrogen membrane.

10. The system of claim 1, wherein the iron catalyst comprises a titanomagnititic black sand.

11. The system of claim 1, wherein the catalyst is promoted by a Group 1 metal.

12. The system of claim 1, wherein the catalyst is operable to catalyze a water-gas-shift (WGS) reaction between water (H₂O) and carbon monoxide (CO).

13. The system of claim 1, wherein the cracker comprises a ZSM-5 zeolite cracking catalyst.

14. The system of claim 9, wherein the hydrogenation apparatus comprises a palladium or platinum on alumina hydrogenation catalyst.

15. The system of claim 9, wherein the isomerization apparatus comprises a ferrierite zeolite isomerization catalyst.

16. The system of claim 1, wherein the liquid transportation fuel product comprises at least one product selected from the group consisting of a gasoline product, a diesel product, and a jet fuel product.

17. The system of claim 1, wherein the liquid transportation fuel product meets a commercial fuel specification.

18. The system of claim 10, wherein the iron catalyst is pelletized with clay and a silica-based binding agent.

19. The system of claim 18, wherein the iron catalyst is reduced with hydrogen at pressures of 50 to 70 psig and temperatures of 500 to 550° C. for up to seven days.

20. The system of claim 19, wherein the iron catalyst catalyst is converted to an active FT catalyst by exposure to CO, syngas, or producer gas at 270° C. to 180° C. at pressures of less than 100 psig for up to 5 days.
